(19) United States
(12) Patent Application Publication
(10) Pub. No.: US 2026/0093146 A1
(43) Pub. Date: Apr. 2, 2026

(54) THERMAL MANAGEMENT OF A HEADS-UP DISPLAY USING A THERMALLY CONDUCTIVE BEZEL

(71) Applicant: HARMAN INTERNATIONAL INDUSTRIES, INCORPORATED, Stamford, CT (US)

(72) Inventors: Chulmin LEE, Gyeonggi-do (KR); Junghoon SEO, Seoul (KR)

(21) Appl. No.: 19/114,994

(22) PCT Filed: Oct. 4, 2023
(86) PCT No.: PCT/US2023/034479

§ 371 Date: Mar. 25, 2025

Related U.S. Application Data
(60) Provisional application No. 63/414,424, filed on Oct. 7, 2022.

(51) Int. Cl. G02F 1/1335; G02B 27/01

(52) U.S. Cl. CPC G02F 1/133628; G02B 27/0149

(57) ABSTRACT

Embodiments of the present disclosure set forth techniques for thermal management in a heads-up display. A picture generation unit includes a light source and a display unit positioned to receive light emitted by the light source, the display unit being configured to generate content for display when the light emitted by the light source is projected through the display unit. The picture generation unit also includes a display surface, the display surface being positioned between the light source and the display surface. The picture generation unit further includes a thermal bezel positioned on a side of the display surface opposite the display unit, the thermal bezel being positioned on one or more portions of the display surface through which the generated content is not projected, wherein the thermal bezel conducts heat away from the display surface.

### CROSS-REFERENCE TO RELATED APPLICATIONS

This application claims priority benefit to U.S. provisional application titled “THERMAL SOLUTION OF A HEADS-UP DISPLAY BY HIGH CONDUCTIVE MATERIAL,” filed on Oct. 7, 2022 and having Ser. No. 63/414,424. This related application is also hereby incorporated by reference in its entirety.

### BACKGROUND

Field of the Various Embodiments The various embodiments relate generally to heads-up displays, and more specifically, to thermal management of a heads-up display using a thermally conductive bezel.

### Description of the Related Art

A vehicle can be equipped with a heads-up display system for presenting information to an occupant (e.g., a driver, an operator, a passenger) of the vehicle. The heads-up display system presents information in a way that allows the occupant to continue looking forward, toward the environment in front of the vehicle, without needing to look down toward an instrument panel, dashboard, or the like. Vehicles of different types can implement a heads-up display to facilitate maintained attention by a vehicle operator on the environment in front of the vehicle.

In a heads-up display system, content is typically projected onto a transparent object (e.g., a windshield of the vehicle, a transparent display positioned between the occupant and the windshield), and the content reflects from the transparent object toward the occupant. A drawback of heads-up display systems is that a picture generation unit (PGU) including e.g., a liquid crystal display (LCD) that generates content for display to the occupant may be subject to excessive heat. One source of heat is environmental solar radiation (e.g., sunlight) reaching the LCD through one or more transparent or reflective surfaces included in the heads-up display such as lenses, mirrors, the windshield, or a transparent display positioned between the occupant and the windshield. Another source of heat may be a backlight included in the PGU, such as an array of light-emitting diodes (LEDs) mounted or affixed to a printed circuit board (PCB) positioned near one surface of the LCD. The backlight provides necessary illumination for the LCD, but also transfers heat to the PGU as a byproduct of its operation. As the temperature of the PGU increases beyond acceptable operating limits, the performance of the PGU may become intermittent or degraded. In some cases, the PGU may cease operating entirely or suffer permanent damage.

An approach to addressing excessive solar radiation reaching the PGU is to reduce the reflectance and/or transmittance of the various surfaces included in the heads-up display. For example, the transparent object can include a film, coating, or other treatment, either on one or more external surfaces or between layers of the transparent object. Likewise, lenses or mirrors in the optical path of the heads-up display may include similar films, coatings or treatments. Lowering the reflectance and/or transmittance of components in the optical path of the heads-up display attenuates the solar radiation incident on the LCD. A drawback of this approach is that manufacturing components with additional films, coatings, or treatments is more expensive compared to manufacturing the same components without them. Another drawback is that the reductions in transmittance and/or reflectance are bi-directional. In addition to attenuating solar radiation incident on the LCD, the films, coatings, or other treatments also cumulatively reduce the intensity of content generated by projecting light through the LCD as the content is transmitted or reflected by the various components in the optical path of the heads-up display. This reduction in intensity results in an undesirable dimming of the content presented to the occupant compared to that achieved without the use of coatings, films, or other treatments to components in the optical path. Increasing the intensity of the backlight illumination applied to the LCD may increase the intensity of the presentation to compensate for the reduced content intensity but results in additional heat generated in the PGU from the backlight. These drawbacks make this approach a less than desirable response to excessive heat at the PGU.

Another approach to addressing excessive heat at the PGU is to apply an active cooling device (e.g., an electric fan) to the PGU to remove accumulated heat by exchanging heated air within or surrounding the PGU with cooler air from the active cooling device's air inlet. Drawbacks of this approach include an increase in noise due to the active cooling device, increased space requirements to exchange heated air for cooler air, and increased manufacturing costs for both the active cooling device and necessary ancillary components. These drawbacks make this approach a less than desirable response to excessive heat at the PGU.

What is needed is an effective way to mitigate excessive heat in a heads-up display system.

### SUMMARY

One embodiment sets forth a picture generation unit comprising a light source and a display unit positioned to receive light emitted by the light source, the display unit being configured to generate content for display when the light emitted by the light source is projected through the display unit. The picture generation unit also includes a display surface, the display surface being positioned between the light source and the display surface. The picture generation unit further includes a thermal bezel positioned on a side of the display surface opposite the display unit, the thermal bezel being positioned on one or more portions of the display surface through which the generated content is not projected, wherein the thermal bezel conducts heat away from the display surface.

One embodiment sets forth an image projection system including a picture generation unit comprising a light source and a display unit positioned to receive light emitted by the light source, the display unit being configured to generate content for display when the light emitted by the light source is projected through the display unit. The picture generation unit also includes a display surface, the display surface being positioned between the light source and the display surface. The picture generation unit further includes a thermal bezel positioned on a side of the display surface opposite the display unit, the thermal bezel being positioned on one or more portions of the display surface through which the generated content is not projected, wherein the thermal bezel conducts heat away from the display surface. The image projection system further includes one or more mirrors positioned to reflect the content generated by the picture generation unit and a transparent object positioned to receive the content reflected by the one or more mirrors, the transparent object reflecting the content toward a user.

Further embodiments provide, among other things, a method of manufacturing a picture generating unit, the method comprising positioning a display unit between a light source and a display surface such that the display unit is positioned to receive light emitted by the light source, the display unit further configured to generate content for display when the light emitted by the light source is projected through the display unit. The method also comprises positioning the display surface between the light source and the display surface. The method further comprises positioning a thermal bezel on a side of the display surface opposite the display unit, the thermal bezel being positioned on one or more portions of the display surface through which the generated content is not projected, wherein the thermal bezel conducts heat away from the display surface.

At least one technical advantage of the disclosed approaches relative to the prior art is that the temperature in a heads-up display system is reduced without the need for active cooling devices or the application of additional films, coatings, or treatments to reflective and/or refractive components in the heads-up display system. In addition, the complexity and manufacturing costs of the heads-up display system are reduced. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computing system, according to various embodiments;

FIG. 2 is a schematic diagram illustrating an image projection system according to various embodiments;

FIG. 3 is a cross-sectional view of the picture generation unit (PGU) of FIG. 1 according to various embodiments;

FIG. 4 is a frontal view of display surface of the PGU of FIG. 3 according to various embodiments; and

FIG. 5 is a flow diagram of method steps for constructing a PGU according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

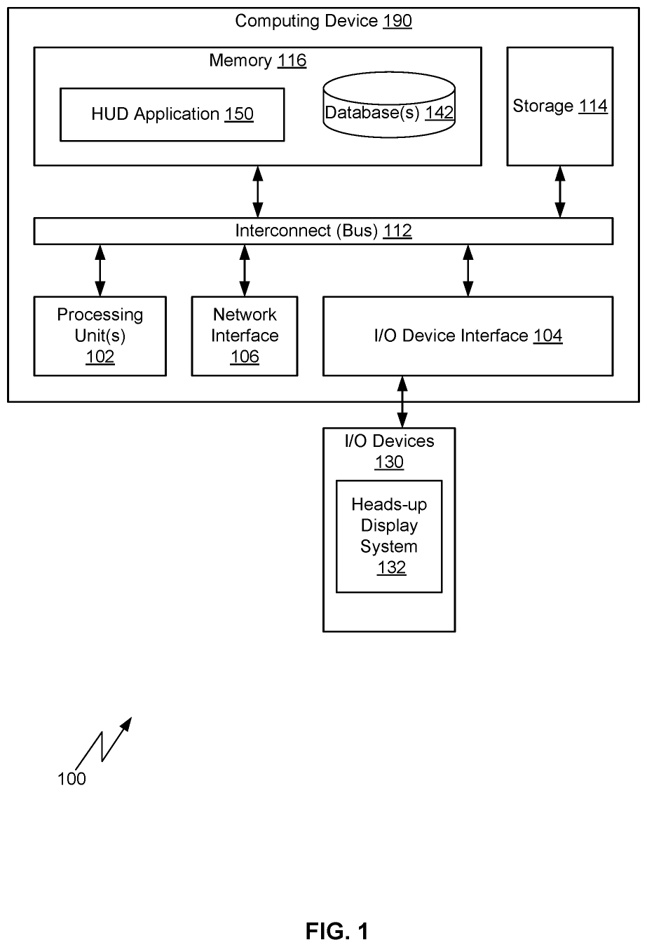

FIG. 1 illustrates a block diagram of a computing system 100 configured to implement one or more aspects of the various embodiments. As shown, computing system 100 includes, without limitation, computing device 190, and input/output (I/O) device(s) 130. Computing device 190 includes, without limitation, one or more processing units 102, I/O device interface 104, network interface 106, interconnect (bus) 112, storage 114, and memory 116. Memory 116 stores database(s) 142 and HUD application 150. Processing unit(s) 102, I/O device interface 104, network interface 106, storage 114, and memory 116 can be communicatively coupled to each other via interconnect 112. In various embodiments, computing system 100 can display content to a user (e.g., a vehicle driver or operator) by projecting images of text, graphics, icons, etc.

As noted above, computing device 190 can include processing unit(s) 102 and memory 116. Computing device 190 can be a system-on-a-chip (SoC). In various embodiments, computing device 190 can be a head unit included in a vehicle system. In some embodiments, computing device 190, or computing system 100 overall, can be an aftermarket system or device added to a vehicle. Generally, computing device 190 can be configured to coordinate the overall operation of computing system 100. The embodiments disclosed herein contemplate any technically feasible system configured to implement the functionality of computing system 100 via computing device 190. Various examples of computing device 190 include wearable devices (e.g., helmet, headset, glasses, etc.), vehicle computing devices (e.g., head units, in-vehicle infotainment systems, driver assistance systems, aftermarket systems), and so forth.

Processing unit(s) 102 can include a central processing unit (CPU), a digital signal processing unit (DSP), a microprocessor, an application-specific integrated circuit (ASIC), a neural processing unit (NPU), a graphics processing unit (GPU), a field-programmable gate array (FPGA), and/or the like. Each processing unit 102 generally comprises a programmable processor that executes program instructions to manipulate input data. In some embodiments, processing unit(s) 102 can include any number of processing cores, memories, and other modules for facilitating program execution. In some embodiments, processing unit(s) 102 can be configured to execute HUD application 150 to provide heads-up display services. In some embodiments, HUD application 150 can generate images containing content based on information from various sources associated with a vehicle (e.g., navigation system, infotainment system, driver assistance system) and causes the content images to be displayed via the computing system 100 of the vehicle.

Storage 114 can include non-volatile storage for applications, software modules, and data, and can include fixed or removable disk drives, flash memory devices, and CD-ROM, DVD-ROM, Blu-Ray, HD-DVD, or other magnetic, optical, solid state storage devices, and/or the like. For example, HUD application 150 and database(s) 142 could be stored in storage 114, and then loaded into memory 116 as needed.

Memory 116 can include a memory module or collection of memory modules. Memory 116 generally comprises storage chips such as random access memory (RAM) chips that store application programs and data for processing by processing unit(s) 102. Processing unit(s) 102, I/O device interface 104, and network interface 106 can be configured to read data from and write data to memory 116. HUD application 150 can be loaded from storage 114 into memory 116. While in memory 116, HUD application 150 can be executed by processing unit(s) 102 to implement the functionality described according to the various embodiments in the present disclosure.

Database(s) 142 can store templates, display elements (e.g., textual characters, graphics, shapes, etc.) and/or palettes of display elements, etc. usable by processing unit(s) 102 to generate images for display via computing system 100 and HUD application 150. That is, database(s) 142 can include one or more repositories of templates, display elements, display element palettes, and/or the like. Database(s) 142 or portions thereof can be stored in storage 114 and loaded into memory 116 as needed. In various embodiments, processing unit(s) 102 can be configured to retrieve templates and/or display elements stored in database(s) 142 to generate images for display. For example, database(s) 142 could store templates, formats, or the like for displaying navigation information via computing system 100, and display elements usable for displaying navigation information (e.g., alphanumeric characters, symbols, icons, graphics, etc.). HUD application 150 can retrieve these templates and elements and generate images that includes the display elements arranged based on the template to present navigation information. In some embodiments, database(s) 142 may receive periodic updates for at least a portion of the data stored in database(s) 142 (e.g., additional and/or updated fonts for characters, additional and/or updated symbols, additional and/or updated graphics, display elements for additional and/or updated languages, etc.) from a remote computing system (e.g., a cloud computing system or a remote server system) via network interface 106 and a network (not shown). In some embodiments, display elements stored in database(s) 142 include one or more of fonts for textual characters, fonts for one or more languages, shapes, icons, graphics, and/or the like. In some embodiments, templates stored in database(s) 142 include templates for arranging and displaying one or more of: navigation information, vehicle speed information, infotainment media information (media playback information), vehicle state or status information, environmental information (e.g., weather), and/or the like.

In some embodiments, computing system 100 can be coupled to a sensor array (not shown), which can include one or more sensor devices that perform measurements and/or acquire data related to certain subjects in an environment. The sensor array can include an outward sensor array and/or an inward sensor array. The outward sensor array can include one or more sensor devices configured to perform measurements and/or acquire data related to the exterior of the vehicle (e.g., environment around the vehicle). The inward sensor array can include one or more sensor devices configured to perform measurements and/or acquire data related to the interior of the vehicle (e.g., vehicle cabin, vehicle occupants). Examples of sensor devices include, without limitation, biometric sensors, physiological sensors, imaging sensors, acoustic sensors, environmental sensors, behavioral sensors, imagers, laser sensors, ultrasound sensors, radar sensors, LIDAR sensor, physical sensors (e.g., touch sensors, pressure sensors, position sensors, an accelerometer, an inertial measurement unit (IMU)), motion sensors, etc. The sensor array can generate sensor data associated with a state and/or context of a vehicle, one or more occupants (e.g., driver, passenger) of the vehicle, and/or the environment around the vehicle. For example, the sensor array could collect biometric data related to the driver (e.g., heart rate, brain activity, skin conductance, blood oxygenation, pupil size, eye motion, galvanic skin response, blood-pressure level, average blood glucose concentration, etc.). Additionally or alternatively, the sensor array can generate sensor data associated with a cabin of the vehicle. For example, the sensor array could generate sensor data about the presence of other occupants in the vehicle, the environment within the cabin of the vehicle, operation of the vehicle, and so forth. Further additionally or alternatively, the sensor array can generate sensor data associated with an environment outside of the vehicle. For example, the sensor array could generate sensor data about the weather outside of the vehicle (e.g., outside temperature), detection of objects in proximity of the vehicle (e.g., other vehicles, people, animals, etc.), detection of road features (e.g., lane markers, road signs, etc.), and so forth. More generally, the sensor array can be a source of information for which computing system 100 can generate images for display. For example, a driver assistance system can process sensor data obtained from the sensor array to generate information, which is passed on to HUD application 150. HUD application 150 can generate images containing content that presents the information obtained from the driver assistance system.

I/O device(s) 130 can include devices capable of receiving input (not shown) (e.g., a keyboard, a mouse, a touch-sensitive screen, a microphone, etc.) for providing input data to computing device 190. I/O device(s) 130 can include devices capable of providing output (e.g., a display screen, one or more speakers, haptic devices, touchless haptic devices, and/or the like. One or more of I/O devices 130 can be incorporated in computing device 190 or can be external to computing device 190. I/O devices 130 can interface with computing device 190 via I/O devices interface 104. In some embodiments, computing device 190 and/or one or more I/O device(s) 130 can be components of a head unit implemented in a vehicle. In some embodiments, HUD application 150 can obtain information from one or more systems and/or sub-systems of the vehicle (e.g., navigation system, infotainment system, driver assistance system) and display that information via computing system 100. More generally, computing system 100 and/or computing device 190 can interface with other systems of the vehicle to acquire information for display.

In various embodiments, I/O devices 130 include a heads-up display system 132. Heads-up display system 132 can generate and project images for viewing by a user (e.g., a vehicle occupant). In some embodiments, heads-up display system can include one or more optical devices (e.g., lens, prisms, mirrors, or the like, or any combination thereof) that can affect a virtual image distance of images projected by heads-up display system 132. In some embodiments, heads-up display system 132 can include an actuator or the like that can orient or reorient heads-up display system 132 or a component thereof (e.g., one or more optical devices in heads-up display system 132) in order to affect an angle of projection of images from heads-up display system 132.

A network (not shown) can enable communications between computing device 190 and other devices in network via wired and/or wireless communications protocols, satellite networks, telephone networks, V2X networks, including Bluetooth, Bluetooth low energy (BLE), wireless local area network (WiFi), cellular protocols, and/or near-field communications (NFC). The network can be any technically feasible type of communications network that allows data to be exchanged between computing device 190 and remote systems or devices, such as a server, a cloud computing system, cloud-based storage, or other networked computing device or system. For example, the network could include a wide area network (WAN), a local area network (LAN), a wireless network (e.g., a Wi-Fi network, a cellular data network), and/or the Internet, among others. Computing device 190 can connect with a network via network interface 106. In some embodiments, network interface 106 is hardware, software, or a combination of hardware and software, which is configured to connect to and interface with one or more networks.

In some embodiments, computing system 100 can include or be coupled to a location module. A location module can include hardware and/or software components for determining a geographic location of computing device 190 (e.g., a current location of the vehicle). The location module can determine a location of computing device 190 via acquisition of geolocation data (e.g., from a global navigation satellite system, such as a global positioning system (GPS), Glonass, Galileo, Beidou, etc.) and/or determination of location based on sensor data from a sensor array (e.g., dead reckoning). The location module can also cross-reference an acquired and/or determined geographic location with a navigation database, which can be stored in database(s) 142, to determine address information corresponding to the geographic location.

In some embodiments, computing device 190 can pair and communicate with another computing device in proximity. That another computing device can couple to computing device 190 via I/O device interface 104, and/or network interface 106 and one or more networks, using any suitable wired (e.g., USB cable) or wireless (e.g., Bluetooth, Wi-Fi) connection. HUD application 150 on computing device 190 can communicate and interface with applications on that another computing device. For example, HUD application 150 can communicate and interface with a navigation application on that another computing device to obtain navigation information, which HUD application 150 can then use to generate images for display.

In some embodiments, computing system 100 is an augmented reality display system. computing system 100 displays content in conjunction with the environment outside (e.g., in front) of the vehicle. That is, computing system 100 can display content that a vehicle occupant would perceive as being overlaid on the environment outside of the vehicle as seen by the user. For example, HUD application 150 could generate images to indicate a navigational route in front of the vehicle as well as landmarks on the route. HUD application 150 could, in conjunction with images of the environment in front of the vehicle, arrange the content and display the content, so that the user sees the environment and the content together.

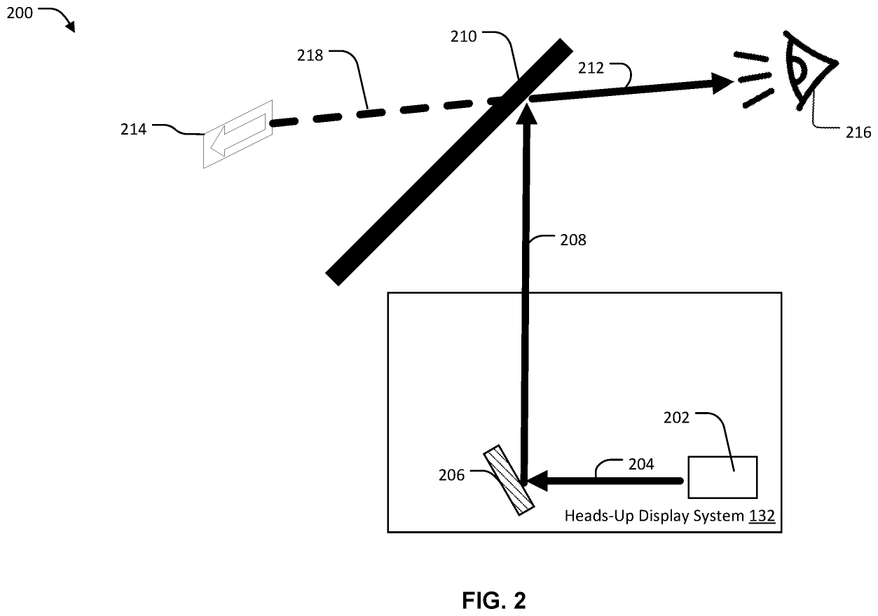

FIG. 2 is a schematic diagram illustrating an image projection system 200 according to various embodiments. Image projection system 200 generates and projects an image for view by a user. In various embodiments, the user may be the driver or another occupant of a vehicle. As shown, the image projection system 200 includes, without limitation, a heads-up display system 132 and a reflective surface 210. Heads-up display system 132 includes, without limitation, a picture generation unit (PGU) 202 and a mirror 206.

In operation, PGU 202 generates content that includes an image. The generated content propagates along an optical path 204 and reflects off of a mirror 206. The generated content further propagates along an optical path 208 and reflects off of reflective surface 210. The generated content then propagates along an optical path 212 to reach an eye 216 of a user. The generated content includes a virtual image 214 that appears to the user as if the virtual image 214 is at a virtual distance 218 away from the eye 216 of a user.

Although only one mirror is shown, image projection system 200 can include multiple mirrors, and one or more of the multiple mirrors can optionally be repositioned or re-oriented. Further, any of the multiple mirrors can be flat, concave, convex, or any other suitable shape.

Reflective surface 210 can be a surface that reflects various light patterns. Reflective surface 210 can be a transparent surface, such as a windshield of a vehicle. Reflective surface 210 can be a translucent or opaque surface, such as dedicated mirror or display surface. Reflective surface 210 can reflect light in a manner that causes a user to view the images at specific positions. In some embodiments, reflective surface 210 can reflect light having certain wavelengths while allowing other wavelengths to pass through. In some embodiments, reflective surface 210 can include two pieces of glass or plastic, with a transparent interlayer sandwiched in between.

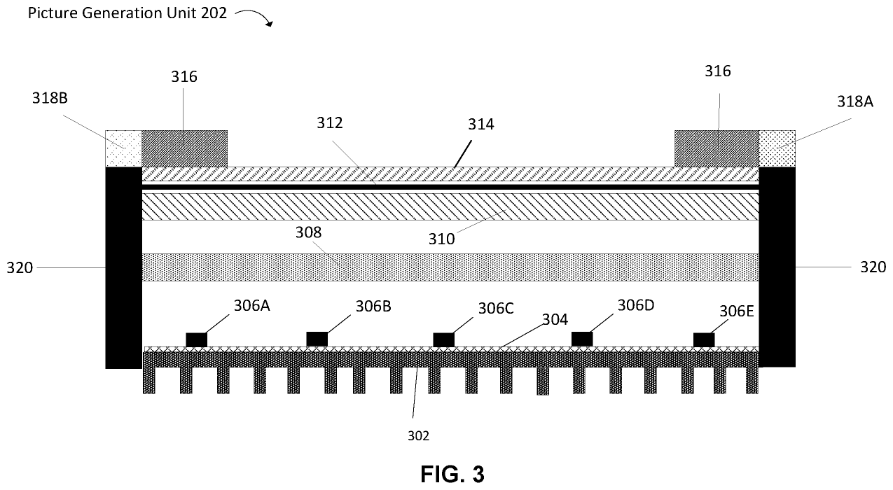

FIG. 3 is a cross-sectional view of PGU 202 according to various embodiments. As shown, PGU 202 includes, without limitation, display unit 310, display surface 314, adhesive layer 312, lens 308, an array of one or more light-emitting diodes (LEDs) 306 (e.g., the one or more LEDs 306A-306E), printed circuit board (PCB) 304, heat sink 302, thermal bezel 316, one or more thermal connectors 318 (e.g., the one or more thermal connectors 318A, 318B), and PGU enclosure 320.

LEDs 306 are affixed to PCB 304 to form a light source that provides backlight illumination through lens 308 to display unit 310. In some embodiments, LEDs 306 can be an array of red, green, and blue LEDs arranged such that the combined backlight illumination provided by LEDs 306 and PCB 304 appears colorless or white. One or more of LEDs 306 can include diffusers (not shown) that distribute the backlight illumination from LEDs 306 and PCB 304 such that the combined backlight illumination has a uniform intensity. In alternative embodiments, LEDs 306 can be replaced or augmented by one or more lighting devices utilizing lighting technologies such as an electroluminescent panel (ELP) or cold cathode fluorescent lamps (CCFLs), instead of using LEDs 306.

PCB 304 further contains driving circuitry to control the illumination of LEDs 306. Via the driving circuitry, PCB 304 can turn LEDs 306 on or off and can vary the intensity of the backlight illumination. PCB 304 can control the illumination of LEDs 306 individually or collectively, to include controlling LEDs affixed to one or more specified regions of PCB 304. In some embodiments, PCB 304 includes one or more reflectors or light guides (not shown) affixed to the surface of PCB 304 and disposed adjacent to LEDs 306. These reflectors or light guides reflect or shape a portion of the combined backlight illumination such that the combined backlight illumination has a uniform intensity.

Lens 308 is positioned between and substantially parallel to PCB 304 and display unit 310. Lens 308 propagates the backlight illumination from LEDs 306 and PCB 304 and can be constructed of any suitable transparent or translucent material, (e.g., plastic, glass, polycarbonate). In some embodiments, lens 308 may be a collimating lens positioned such that backlight illumination incident on lens 308 exits lens 308 as light rays that are substantially parallel to one another. In alternative embodiments, lens 308 may be a diffusing lens arranged such that backlight illumination exiting lens 308 has a uniform intensity across the surface of lens 308. In some embodiments, lens 308 can reduce the intensity of certain wavelengths of light such as infrared or ultraviolet light while allowing other wavelengths of light to pass through without reducing the intensity of these other wavelengths.

The content to be projected by PGU 202 is generated by display unit 310 as a pattern of regions having different levels of transparency by controlling an array of electrodes within display unit 310. For example, a fully transparent region allows the backlight illumination generated by the one or more LEDs 306 and PCB 304 to pass through display unit 310 without a change in brightness. As another example, a partially translucent region allows the backlight illumination to pass through display unit 310 while attenuating the brightness. As yet another example, a fully opaque region does not allow the backlight illumination to pass through that region. In some embodiments, a partially translucent region can change a color of the backlight illumination that passes through that region. In some embodiments, display unit 310 can be a liquid crystal display (LCD), such as a thin-film transistor (TFT) LCD. Display unit 310 can generate content at any suitable resolution.

The backlight illumination projected through display unit 310 to generate the content for display is further projected through adhesive layer 312. Adhesive layer 312 can include any suitable transparent or translucent adhesive and can be disposed throughout all or a portion of the space between display unit 310 and display surface 314. In alternative embodiments where display surface 314 is affixed directly to display unit 310, for example by a mounting bracket positioned to apply a clamping force on display unit 310 and display surface 314, adhesive layer 312 can be omitted.

Display surface 314 can be any suitable transparent material, (e.g., plastic, glass, polycarbonate). In some embodiments, display surface 314 can reduce the intensity of certain wavelengths of light such as infrared or ultraviolet light while allowing other wavelengths of light to pass through without reducing the intensity of these other wavelengths. Display surface 314 can include a non-reflective coating to reduce glare from light incident on the surface of display surface 314 opposite of display unit 310.

Thermal bezel 316 is affixed to a first portion of display surface 314 that is not used to propagate generated content from PGU 202. In various embodiments, thermal bezel 316 surrounds a second portion of display surface 314 through which the generated content is projected from PGU 202.

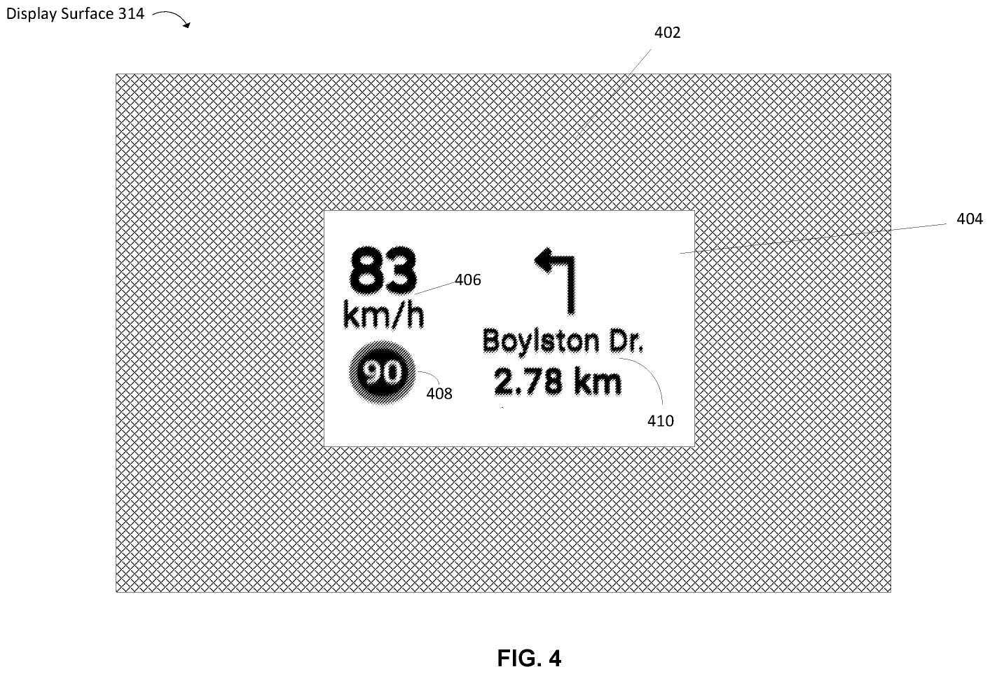

FIG. 4 is an exemplary frontal view of display surface 314. As shown, display surface 314 includes, without limitation, an unused portion 402 and a used portion 404.

Used portion 404 of display surface 314 corresponds to the portion of display surface 314 through which the content is generated using display unit 310. The content can include, for example, current vehicle speed 406, current speed limit 408, and navigation data 410. It is understood that the exemplary content shown in FIG. 4 is representative only, and in other embodiments, different kinds and/or arrangements of content are possible. Although FIG. 4 depicts used portion 404 located centrally within display surface 314, used portion 404 can be located at any position within display surface 314.

Unused portion 402 of display surface 314 corresponds to the portion of display unit 310 through which no content is generated. As discussed above in reference to FIG. 3, thermal bezel 316 can be affixed to the entirety of unused portion 402 or to a portion of unused portion 402 Referring back to FIG. 3, thermal bezel 316 conducts heat away from display surface 314 and can include any thermally conductive material. In various embodiments, thermal bezel 316 includes a graphite sheet. Thermal bezel 316 can be affixed to display surface 314 with any suitable thermally conductive adhesive (not shown) or can be positioned in direct contact with display surface 314 and affixed to display surface 314 via applied pressure from, for example, one or more clamps or mounting brackets.

One or more of thermal connectors 318 is coupled to thermal bezel 316. Thermal connector(s) 318 include a thermally conductive material (e.g., aluminum, steel, magnesium, copper). Thermal connector(s) 318 conduct heat away from thermal bezel 316. As shown, thermal connector(s) 318 can be disposed adjacent to one or more portions of thermal bezel 316 in contact with the corresponding outside edges of thermal bezel 316. In various embodiments, thermal connector(s) 318 can be disposed at the corners of thermal bezel 316, along a portion or the entirety of one or more outside edges of thermal bezel 316, or fully surrounding the outside edges of thermal bezel 316. In alternative embodiments, thermal connector(s) 318 can be affixed to the surface of thermal bezel 316 such that thermal bezel 316 is disposed between thermal connector(s) 318 and display surface 314.

PGU enclosure 320 surrounds at least the sides of the various components of PGU 202. In some embodiments, one or more of thermal bezel 316, thermal connector(s) 318, display surface 314, display unit 310, lens 308, PCB 304, and heat sink 302 are mounted within and/or mounted to one or more interior surfaces of PGU enclosure 320. PGU enclosure 320 can include an upper opening exposing at least the used portion 404 of display surface 314 and a lower opening exposing heat sink 302 to the external environment surrounding PGU enclosure 320. PGU enclosure 320 can be constructed at least partially of a thermally conductive material (e.g., aluminum, steel, magnesium, copper) so that PGU enclosure 320 helps conduct heat away from the thermal connector(s) 318 and/or other components affixed to PGU enclosure 320. PGU enclosure 320 radiates the conducted heat into the external environment surrounding PGU enclosure 320.

Heat sink 302 is affixed to PCB 304 and conducts heat away from PCB 304. Heat sink 302 can include one or more posts and/or fins to increase the surface area and thermal conductivity of heat sink 302. Heat sink 302 can be constructed of a thermally conductive material (e.g., copper, aluminum, aluminum alloy) and radiates heat into the surrounding environment external to PGU enclosure 320. In various embodiments where heat sink 302 is affixed to PGU enclosure 320, heat sink 302 also conducts heat away from or into PGU enclosure 320 depending on the relative temperatures of heat sink 302 and PGU enclosure 320.

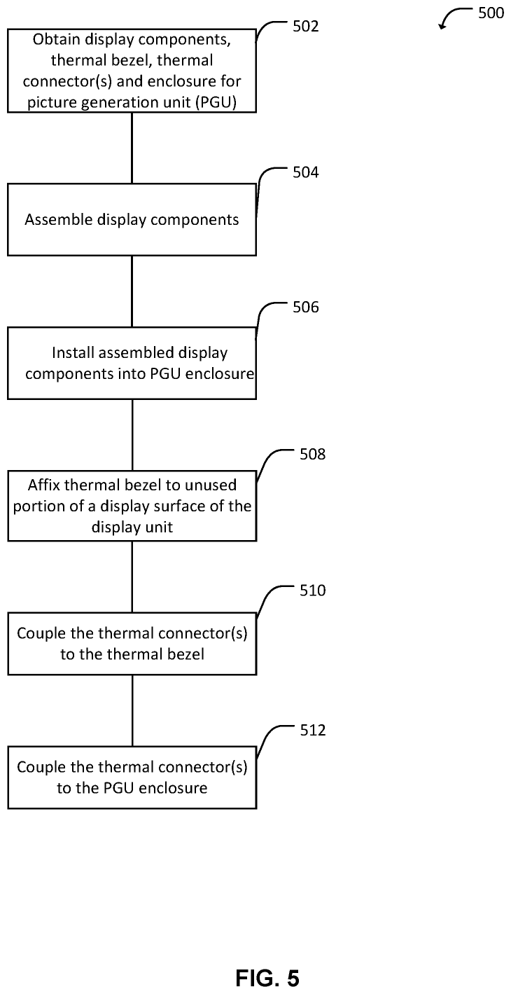

FIG. 5 is a flow diagram of method steps for constructing the PGU 202, according to various embodiments. Although the method steps are described in conjunction with the systems of FIGS. 1-4, persons skilled in the art will understand that any system configured to perform the method steps, in any order, falls within the scope of the various embodiments.

A method 500 begins at a step 502 by obtaining components for PGU 202 including, without limitation, display components, a thermal bezel 316, thermal connector(s) 318, and a PGU enclosure 320. Display components include, without limitation, LEDs 306, a PCB 304, a heat sink 302, a lens 308, a display unit 310 and a display surface 314.

At a step 504, the display components are assembled. LEDs 306 are affixed to a surface of PCB 304. Alternatively, LEDs 306 are pre-mounted to a surface of PCB 304. Heat sink 302 is affixed to a second surface of PCB 304 opposite the surface to which LEDs 306 are affixed or pre-mounted. Lens 308 is disposed between LEDs 306 and display unit 310, and display surface 314 is affixed to display unit 310. Display surface 314 can be affixed to display unit 310 using an adhesive layer 312 disposed between display unit 310 and display surface 314. Alternatively, display surface 314 can be affixed directly to display unit 310 with a mounting flange, a bracket, or by using one or more fasteners such as screws, bolts or clips.

At a step 506, the assembled display components are installed into PGU enclosure 320. The assembled display components can be attached to brackets or flanges disposed between the assembled display components and PGU enclosure 320. Alternatively, the assembled display components can be installed into a chassis and the chassis affixed to one or more interior surfaces of PGU enclosure 320, such as by one or more brackets or flanges.

At a step 508, thermal bezel 316 is affixed to an unused portion 402 of display surface 314 for display unit 310. As discussed above in reference to FIGS. 3 and 4, thermal bezel 316 can be affixed to the entirety of unused portion 402 or to a portion of unused portion 402. Thermal bezel 316 can be affixed to unused portion 402 of display surface 314 with any suitable thermally conductive adhesive or can be positioned in direct contact with display surface 314 and affixed to display surface 314 via applied pressure from, for example, one or more clamps or mounting brackets.

At a step 510, the one or more thermal connector(s) 318 are coupled to the thermal bezel 316. As shown in FIG. 3, thermal connector(s) 318 can be disposed adjacent to one or more portions of thermal bezel 316 in contact with the corresponding outside edges of thermal bezel 316. In various embodiments, thermal connector(s) 318 can be disposed at the corners of thermal bezel 316, along a portion or the entirety of one or more outside edges of thermal bezel 316, or fully surrounding the outside edges of thermal bezel 316. In alternative embodiments, thermal connector(s) 318 can be affixed to the surface of thermal bezel 316 such that thermal bezel 316 is disposed between thermal connector(s) 318 and display surface 314.

At a step 512, one or more thermal connector(s) 318 are coupled to PGU enclosure 320. Thermal connector(s) 318 can be affixed to PGU enclosure 320 using suitable fasteners such as screws, clips, or bolts. In alternative embodiments, the shape and physical dimensions of PGU enclosure 320 can locate and constrain thermal connector(s) 318 in direct contact with PGU enclosure 320 without the need for fasteners.

As discussed above and further emphasized here, FIG. 5 is merely an example which should not unduly limit the scope of the claims. One of ordinary skill in the art would recognize many variations, alternatives, and modifications. In some embodiments, thermal bezel 316 comes pre-affixed to display screen 314 from the manufacturer. In such embodiments, step 508 is omitted.

In sum, excessive temperature in a heads-up display system in a vehicle can be mitigated by affixing a thermal bezel to a portion of a display surface of a picture generation unit (PGU). The thermal bezel is affixed to some or all of the portion of the display surface that is not used for displaying images. The thermal bezel surrounds the portion of the display surface that is used to display images. The thermal bezel can be affixed to the display surface with any suitable thermally conductive adhesive or can be positioned in direct contact with the display surface and affixed to the display surface via applied pressure from, for example, one or more clamps or mounting brackets. The thermal bezel absorbs heat from the display unit and conducts the heat to one or more thermal connectors coupled with the thermal bezel. The one or more thermal connectors are further coupled to an enclosure of the PGU and/or other components of the heads-up display system and conduct heat from the thermal bezel to the enclosure. A heat sink can also be attached to the enclosure to help remove heat from the enclosure.

At least one technical advantage of the disclosed approaches relative to the prior art is that the temperature in a heads-up display system is reduced without the need for active cooling devices or the application of additional films, coatings, or treatments to reflective and/or refractive components in the heads-up display system. In addition, the complexity and manufacturing costs of the heads-up display system are reduced. These technical advantages provide one or more technological improvements over prior art approaches.
1. In some embodiments, a picture generation unit comprises a light source, a display unit positioned to receive light emitted by the light source, the display unit being configured to generate content for display when the light emitted by the light source is projected through the display unit, a display surface, the display unit being positioned between the light source and the display surface, and a thermal bezel positioned on a side of the display surface opposite the display unit, the thermal bezel being positioned on one or more portions of the display surface through which the generated content is not projected, wherein the thermal bezel conducts heat away from the display surface.
2. The picture generation unit of clause 1, wherein the thermal bezel comprises a graphite sheet.
3. The picture generation unit of clauses 1 or 2, wherein the thermal bezel is affixed to the display surface using a thermally conductive adhesive disposed between the thermal bezel and the display surface.
4. The picture generation unit of any of clauses 1-3, further comprising one or more thermal connectors and an enclosure, wherein the one or more thermal connectors are coupled between the thermal bezel and the enclosure.
5. The picture generation unit of any of clauses 1-4, further comprising a heat sink coupled to at least one of the light source or the enclosure.
6. The picture generation unit of any of clauses 1-5, wherein the one or more thermal connectors are disposed along one or more outside edges of the thermal bezel.
7. The picture generation unit of any of clauses 1-6, wherein the thermal bezel is disposed between the one or more thermal connectors and the display surface.
8. The picture generation unit of any of clauses 1-7, wherein the light source comprises one or more light-emitting diodes affixed to a printed circuit board.
9. The picture generation unit of any of clauses 1-8, wherein the display unit is a thin-film transistor liquid crystal display.
10. The picture generation unit of any of clauses 1-9, further comprising a lens positioned between the light source and the display unit.
11. The picture generation unit of any of clauses 1-10, wherein the picture generation unit is used to generate projected content for a heads-up display.
12. In some embodiments, an image projection system includes a picture generation unit comprising a light source and a display unit positioned to receive light emitted by the light source, the display unit being configured to generate content for display when the light emitted by the light source is projected through the display unit, a display surface, the display unit being positioned between the light source and the display surface, and a thermal bezel positioned on a side of the display surface opposite the display unit, the thermal bezel being positioned on one or more portions of the display surface through which the generated content is not projected, wherein the thermal bezel conducts heat away from the display surface, one or more mirrors positioned to reflect the content generated by the picture generation unit, and a transparent object positioned to receive the content reflected by the one or more mirrors, the transparent object reflecting the content toward a user.
13. The image projection system of clause 12, wherein the thermal bezel comprises a graphite sheet.
14. The image projection system of clause 12 or 13, wherein the thermal bezel is affixed to the display surface using a thermally conductive adhesive disposed between the thermal bezel and the display surface.
15. The image projection system of any of clauses 12-14, wherein the picture generation unit further comprises one or more thermal connectors and an enclosure, wherein the one or more thermal connectors are coupled between the thermal bezel and the enclosure.
16. The image projection system of any of clauses 12-15, wherein the one or more thermal connectors are disposed along one or more outside edges of the thermal bezel.
17. The image projection system of any of clauses 12-16, wherein the thermal bezel is disposed between the one or more thermal connectors and the display surface.
18. The image projection system of any of clauses 12-17, wherein the transparent object is a windshield of a vehicle.
19. In some embodiments, a method of manufacturing a picture generating unit comprises positioning a display unit between a light source and a display surface such that the display unit is positioned to receive light emitted by the light source, the display unit further configured to generate content for display when the light emitted by the light source is projected through the display unit, positioning the display surface between the light source and the display surface, and positioning a thermal bezel on a side of the display surface opposite the display unit, the thermal bezel being positioned on one or more portions of the display surface through which the generated content is not projected, wherein the thermal bezel conducts heat away from the display surface.
20. The method of manufacturing a picture generation unit of clause 19, wherein the thermal bezel comprises a graphite sheet.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

1. A picture generation unit comprising:
a light source;
a display unit positioned to receive light emitted by the light source, the display unit being configured to generate content for display when the light emitted by the light source is projected through the display unit;
a display surface having a first portion and a second portion, the display unit being positioned between the light source and the display surface, wherein the first portion is a portion of the display surface corresponding to a portion of the display unit through which no content is generated, and the second portion is a portion of the display surface through which content is generated using the display unit; and
a thermal bezel positioned on a side of the display surface opposite the display unit, the thermal bezel being positioned on the first portion of the display surface;
wherein the thermal bezel conducts heat away from the display surface.

2. The picture generation unit of claim 1, wherein the thermal bezel comprises a graphite sheet.

3. The picture generation unit of claim 1, wherein the thermal bezel is affixed to the display surface using a thermally conductive adhesive disposed between the thermal bezel and the display surface.

4. The picture generation unit of claim 1, wherein the first portion surrounds the second portion.

5. The picture generation unit of claim 1, wherein the thermal bezel is affixed to an entirety of the first portion.

6. The picture generation unit of claim 1, wherein a width of the display surface and a width of the display unit are a same width.

7. The picture generation unit of claim 1, further comprising:
one or more thermal connectors; and
an enclosure;
wherein the one or more thermal connectors are coupled between the thermal bezel and the enclosure.

8. The picture generation unit of claim 7, further comprising a heat sink coupled to at least one of the light source or the enclosure.

9. The picture generation unit of claim 7, wherein the one or more thermal connectors are disposed along one or more outside edges of the thermal bezel.

10. The picture generation unit of claim 9, wherein the one or more thermal connectors are disposed along an entirety of the one or more outside edges of the thermal bezel.

11. The picture generation unit of claim 7, wherein the one or more thermal connectors are disposed at corners of the thermal bezel.

12. The picture generation unit of claim 7, wherein the thermal bezel is disposed between the one or more thermal connectors and the display surface.

13. The picture generation unit of claim 1, wherein the light source comprises one or more light-emitting diodes affixed to a printed circuit board.

14. The picture generation unit of claim 1, wherein the display unit is a thin-film transistor liquid crystal display.

15. The picture generation unit of claim 1, further comprising a lens positioned between the light source and the display unit.

16. The picture generation unit of claim 1, wherein the picture generation unit is used to generate projected content for a heads-up display.

17. An image projection system comprising:
a picture generation unit comprising:
a light source;
a display unit positioned to receive light emitted by the light source, the display unit being configured to generate content for display when the light emitted by the light source is projected through the display unit;
a display surface, the display unit being positioned between the light source and the display surface; and
a thermal bezel positioned on a side of the display surface opposite the display unit, the thermal bezel being positioned on one or more portions of the display surface through which the generated content is not projected, wherein the thermal bezel conducts heat away from the display surface;
one or more mirrors positioned to reflect the content generated by the picture generation unit; and
a transparent object positioned to receive the content reflected by the one or more mirrors, the transparent object reflecting the content toward a user.

18. The image projection system of claim 17, wherein the transparent object is a windshield of a vehicle.

19. A method of manufacturing a picture generating unit, comprising:
positioning a display unit between a light source and a display surface such that the display unit is positioned to receive light emitted by the light source, the display unit further configured to generate content for display when the light emitted by the light source is projected through the display unit;
positioning the display surface between the light source and the display surface, the display surface having a first portion and a second portion and wherein the first portion is a portion of the display surface corresponds to a portion of the display unit through which no content is generated, and the second portion is a portion of the display surface through which content is generated using the display unit; and
positioning a thermal bezel on a side of the display surface opposite the display unit, the thermal bezel being positioned on the first portion.

20. The method of claim 19, wherein the thermal bezel comprises a graphite sheet.
